(19) United States
(12) Patent Application Publication
(10) Pub. No.: US 2022/0011113 A1
(43) Pub. Date: Jan. 13, 2022

(54) INERTIAL MEASUREMENT UNITS AS VIBROACOUSTIC DATA RECEIVERS

(71) Applicant: CARNEGIE MELLON UNIVERSITY, Pittsburgh, PA (US)

(72) Inventors: Christopher Harrison, Pittsburgh, PA (US); Bo Robert Xiao, Pittsburgh, PA (US)

(73) Assignee: CARNEGIE MELLON UNIVERSITY, Pittsburgh, PA (US)

(21) Appl. No.: 17/355,729

(22) Filed: Jun. 23, 2021

Related U.S. Application Data
(60) Provisional application No. 63/042,635, filed on Jun. 23, 2020.

(51) Int. Cl. G01C 21/18; G01C 19/5719; G01P 15/14

(52) U.S. Cl. CPC G01C 21/18; G01P 15/14; G01C 19/5719

(57) ABSTRACT

Inertial measurement units with gyroscopic sensors are standard in mobile computers. The present invention shows that these sensors can be co-opted for vibroacoustic data reception. The present invention illustrates a new capability for an old sensor utilizing the commodity gyroscope sensor found in most average smartphones and a low-cost transducer to the present invention can transmit error-corrected data at 2028 bits per sec with the expectation that 95% of packets will be successfully received.

### CROSS-REFERENCE TO RELATED APPLICATION

This application claims priority to U.S. Provisional Application Ser. No. 63/042,635, filed on Jun. 23, 2020, which application is incorporated by reference herein in its entirety.

### GOVERNMENT RIGHTS

None

### BACKGROUND OF THE INVENTION

### Field of the Invention

With the rise of the Internet of Things (“IoT”), pairing and transmission schemes that gracefully scale to dense ecosystems of “smart” devices are going to be more important than ever. Unfortunately, wireless schemes (e.g., Bluetooth, NFC, and ultrasound) are ill-suited for this task, as their long range makes interactions less explicit. Mere proximity to a device should not be interpreted as an interaction request. For this reason, most systems often rely on physical buttons to trigger time-limited open connection windows (inherently unsafe), or temporary PINs to make sure others nearby do not connect (needlessly cumbersome).

Inertial Measurement Units (“IMU”s) with gyroscopic sensors are now standard in mobile computers. The present invention shows—for the first time—that these sensors can be co-opted for vibroacoustic data reception. Unlike wireless transmission schemes, which cannot distinguish between devices that are near vs. touching, the present invention requires direct physical contact to a transmitting (i.e., vibrating) surface. This approach is more targeted and explicit in nature, making it well suited for contexts with many targets or requiring presence and intent. What follows is a discussion of the implementation and results from a data transmission study demonstrating a transfer rate over 2000 bits per second with less than 5% packet loss—an order of magnitude faster than previous IMU-based approaches at a quarter of the loss rate. Overall, the present invention illuminates a new capability for an old sensor, which could be enabled on mobile devices with a simple software update.

Smart mobile devices contain a rich suite of sensors, including gyroscopes for sensing rotational acceleration. Gyroscopes typically operate in concert with an accelerometer and magnetometer as part of an Inertial Measurement Unit, providing 9-axis orientation data to applications. Of these three sensors, gyroscopes almost always provide the highest raw bandwidth. For instance, modern IMU offerings from Bosch® (e.g., BHI160), InvenSense® (e.g., MPU6500 series) and STMicroelectronics® (e.g., LSM6DSL) have maximum accelerometer output data rates (“ODR”) of 1.6, 4.5 and 1.6 kHz respectively. In contrast, gyroscope ODR on these same sensors are 3.2, 9.0 and 12.6 kHz respectively. Gyroscopes also tend to be more sensitive to vibration than their linear acceleration counterparts.

The present invention takes advantage of gyroscopes' unique characteristics to show that these ubiquitous sensors can be co-opted as vibroacoustic data receivers. This allows a smartphone (or, in principle, any IMU-equipped device) to be pressed to a surface and receive data encoded as minute structured vibrations induced by a low-cost transducer (e.g., piezo, voice coil), which can be embedded in an object 15. Unlike wireless transmission approaches, which cannot distinguish between devices that are near vs. touching, the present invention requires direct physical contact (i.e., acoustic coupling). This property makes the present invention targeted and explicit in nature, requiring presence and purposefulness.

As will be discussed more fully herein, the present invention was evaluated using four vibration-modulation schemes (ASK, PSK, DPSK, and FSK) and their performance in a data transmission study was tested. FSK was the best performing, achieving 2028 bits per second when correcting for the 95th percentile of bit error (i.e., successfully receiving 95% of all packets). This performance is an order of magnitude higher in speed than previous IMU-based approaches. See for example, Laput, G., Xiao, R. and Harrison, C. (2016), ViBand: High-Fidelity Bio-Acoustic Sensing Using Commodity Smartwatch Accelerometers, In Proceedings of the 29th Annual Symposium on User Interface Software and Technology (UIST '16)(ACM, New York, N.Y., USA, 321-333. DOI: https://doi.org/10.1145/2984511.29845820; Roy, N., Gowda M. and Choudhury R. R. (2015), Ripple: communicating through physical vibration; In Proceedings of the 12th USENIX Conference on Networked Systems Design and Implementation (NSDI'15)(USENIX Association, Berkeley, Calif., USA, 265-278); and Zhong, L., El-Daye, D., Kaufman, B., Tobaoda, N., Mohamed, T., and Liebschner, M. (2007), OsteoConduct: wireless body-area communication based on bone conduction, In Proceedings of the ICST 2nd international conference on Body area networks (BodyNets '07)(ICST, Brussels, Belgium, Belgium, Article 9, 8 pages). The present invention's technique is also robust to ambient noise and vibrations—in addition to collecting study data on a static table, research on the present invention also captured data in two extreme vibration conditions: an airplane in flight and when the receiving smartphone was playing music. While the present invention may not directly compete with technologies like WiFi, Bluetooth and NFC, it has unique pros and cons that make it a valuable addition to the toolbox of techniques that can be drawn upon in the creation of future systems.

### Description of the Related Art

There is a vast literature on data transmission, especially wired and wireless techniques. Research on the present invention concentrated on two bodies of work that most directly relate to the present invention. First, a review of the general approaches used in mobile devices, namely smartphones, is provided and then a focus on vibroacoustic methods in the literature.

Smartphone Data Transmission: Modern smartphones primarily use wireless radio technologies, such as Bluetooth, Wi-Fi and cellular radio for data transmission. However, a number of techniques using other media have been explored.

The most widely deployed smartphone standard for short-range communication is NFC (i.e., near-field communication), which uses a low-power radio signal to exchange data with a proximate receiver. Although NFC supports a high bit rate (424 kbits/sec in the fastest configuration), it does not require physical contact between the devices, and thus can be accidentally triggered. For this reason, current implementations have users manually initiate NFC transactions. It has also been repeatedly demonstrated that this approach is vulnerable to interception by interlopers. See Brown, T. W., Diakos, T. and Briffa, J. A., Evaluating the eavesdropping range of varying magnetic field strengths in nfc standards, In Antennas and Propagation (EuCAP), 2013 7th European Conference on (2013), IEEE, pp. 3525-3528; and Diakos, T. P., Briffa, J. A., Brown, T. W., and Wesemeyer, S. Eavesdropping near-field contactless payments: a quantitative analysis, he Journal of Engineering 1, 1 (2013).

Acoustic data transmission techniques, typically using inaudible ultrasonic frequencies, have also been explored in both the academic and commercial (e.g., Chirp and AT&T) spheres. Chirp, in particular, is a commercially deployed approach that transmits data at around 25-100 bits per second depending on ambient noise characteristics. Like NFC, these approaches do not require physical contact.

Finally, optical techniques for proximate pairing have also been explored, e.g. FlashLight and CapCam, where the device's camera is used to receive a color-modulated signal. These techniques provide low bandwidth (e.g. 200 bits/sec for CapCam) and require a screen or color LED in order to present the data.

Vibroacoustic Data Transmission: More closely related to the present invention are methods that use vibration to transmit data. Hwang et al. uses on-off keying at 5 bits per second to transmit data between two smartphones placed on a flat surface. See Hwang, I., Cho, J., and Oh, S., Privacy-aware communication for smartphones using vibration, In Embedded and Real-Time Computing Systems and Applications (RTCSA)(2012 IEEE 18th International Conference on (2012), IEEE, pp. 447-452). Osteoconduct used a similar 5 bit-per-second on-off keying approach to transmit vibration-encoded data to different parts of the human body via bone conduction.

Ripple was the first system to demonstrate robust, high-bit-rate vibrational data transmission, achieving 196 bits per second from a vibrating motor to a mechanically-coupled accelerometer. The follow-on work, Ripple II, uses a vibration motor to generate vibroacoustic waves, and a pair of microphones (or an acoustically isolated microphone) to receive them, achieving up to 30 kilobits per second of bandwidth. See Roy, N. and Choudhury, R. R. (2016), Ripple II: faster communication through physical vibration, In Proceedings of the 13th Usenix Conference on Networked Systems Design and Implementation (NSDI'16)(USENIX Association, Berkeley, Calif., USA, 671-684). The use of microphones necessitated significant amounts of noise filtering and processing to avoid ambient noise, whereas IMUS are inherently much less sensitive to acoustic interference.

ViBand demonstrated bit rates similar to Ripple using a commodity smartwatch IMU as the sensor, with the vibrations conducted through the user's fingers, hands and wrist. ViBand explores some of the same territory as the present invention—using an accelerometer IMU to receive data—but with significantly lower bandwidth (˜200 bits per second).

None of these past systems used gyroscopic sensors, which is an interesting class of widely-deployed sensing hardware. The present invention demonstrates that, with an off-the-shelf widely-deployed gyroscopic sensor, a smart device modified according to the present invention can receive coded data at over 2000 bits per second.

### BRIEF SUMMARY OF THE INVENTION

One embodiment of the present invention utilizes the commodity gyroscope sensor found in most average smart devices and a low-cost transducer to transmit error-corrected data at 2028 bits per sec with the expectation that 95% of packets will be successfully received. Another embodiment of the present invention is a method of transmitting data to a smart device containing a gyroscope sensor by programming the smart device to receive and translate data from a transducer that is able to produce ultrasonic vibrations. The transducer should be located on a surface that is distinct from the smart device. Data is packetizing and a header is prepended to the packet(s). The transducer is programed to transmit the data packet(s) and header(s). Then the smart device can be touched to the transducer (or the object equipped with the transducer) so that the data can be transmitted to the gyroscope and converted to usable information by the smart device.

Another embodiment of the present invention is a method of transmitting data, through physical touching, acoustic coupling or acoustic touching, from an object to a smart device comprising a gyroscope sensor. The method according to this embodiment comprises configuring the object with a transducer that is capable of producing vibrations and configuring the transducer to transmit data through the vibrations. For this embodiment, when the smart device is touching the object, the gyroscope can detect the transmitted data and vibrations and converted to usable information by the smart device.

An additional embodiment of the present invention is a method of receiving data from an object that produces vibrations. This method comprises selecting a smart device comprising a gyroscope to receive data that is in the form of vibrations and touching the smart device to the object configured with a transducer that is configured to produce vibrations and to transmit data through the vibrations. For this embodiment, the data can be transmitted from the object to the smart device.

Another embodiment of the present invention is a system for transmitting data through physical touching, acoustic coupling or acoustic touching. The system according to this embodiment comprises an object, a transducer that is associated with the object and capable of producing vibrations for transmission of data and a smart device equipped with a gyroscope configured to receive the data from the transducer when the smart device touches the object.

The present invention also includes a secure payment method comprising touching a smart device comprising a gyroscope, which smart device is configured to receive and translate data, to an object having a transducer, which transducer is capable of producing vibrations that transmit data. For this method, the touching of the smart device to the object enables the data from the object to be transmitted securely to the gyroscope.

### BRIEF DESCRIPTION OF THE SEVERAL VIEWS OF THE DRAWINGS

For the purpose of facilitating understanding of the invention, the accompanying drawings and description illustrate preferred embodiments thereof, from which the invention, various embodiments of its structures, construction, method of operation and many advantages may be understood and appreciated.

FIG. 1 is a spectrogram of the gyroscope at a 32.082 kHz sampling rate with frequency on the y-axis and time on the x-axis;

FIG. 2 is 4-ASK-modulated data, showing the 2-level packet preamble (left) and main 4-level payload with amplitude on the y-axis and time on the x-axis;

FIG. 3 shows one embodiment of the present invention with a smart phone being touched to a piezo buzzer (the disc);

FIG. 4 is a table showing the 95^{th} percentile bit error rates;

FIGS. 5A through 5C illustrate the present invention's use of phone gyroscopes sensors for vibroacoustic data communication;

FIGS. 6A through 6D show devices containing speakers being used to emit structured vibrations (with frequency on the y-axis and time on the x-axis for FIGS. 6B and 6D);

FIGS. 7A and 7B show transmission devices emitting unique transaction identifiers that could be received by other devices according to the present invention for rapid payment;

FIG. 8 shows a smart device being intuitively paired according to the present invention;

FIGS. 9A and 9B illustrate devices gaining WiFi access by tapping a phone to a router utilizing the present invention;

FIGS. 10A and 10B show devices such as printers sharing information via the present invention;

FIGS. 11A and 11B illustrate how the present invention can be utilized to enable devices to handoff functionality to other devices;

FIGS. 12A and 12B illustrate the use of the present invention on large, ridged surfaces, such as glass windows;

FIG. 13 illustrates the steps of a method according to the present invention;

and

FIG. 14 is a block diagram of a smart device acoustically touching an object having an IMU and a gyroscope.

### DETAILED DESCRIPTION OF THE INVENTION

The present invention will be understood more readily by reference to the following detailed description of the invention and the accompanying figures, which form a part of this disclosure. This invention is not limited to the specific devices, methods, processes, elements or parameters described and/or shown herein and the terminology used herein is for the purpose of describing particular embodiments and is by way of example only and not intended to be limiting of the claimed invention. Any and all patents and other publications identified in this specification are incorporated by reference as though fully set forth herein. The following detailed descriptions should not be taken in a limiting sense. The accompanying figures and drawings are hereby incorporated by reference.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

It is to be understood that the invention may assume alternative variations and step sequences, except where expressly specified to the contrary. It also is to be understood that the specific devices and processes illustrated in the attached drawings and described in this specification are simply exemplary embodiments of the invention. Hence, specific dimensions and other physical characteristics related to the embodiments disclosed herein are not to be considered as limiting.

While the disclosure has been described in detail and with reference to specific embodiments thereof, it will be apparent to one skilled in the art that various changes and modifications can be made thereto without departing from the spirit and scope of the embodiments. Thus, it is intended that this application covers modifications and variations of this disclosure provided they come within the scope of the appended claims and their equivalents.

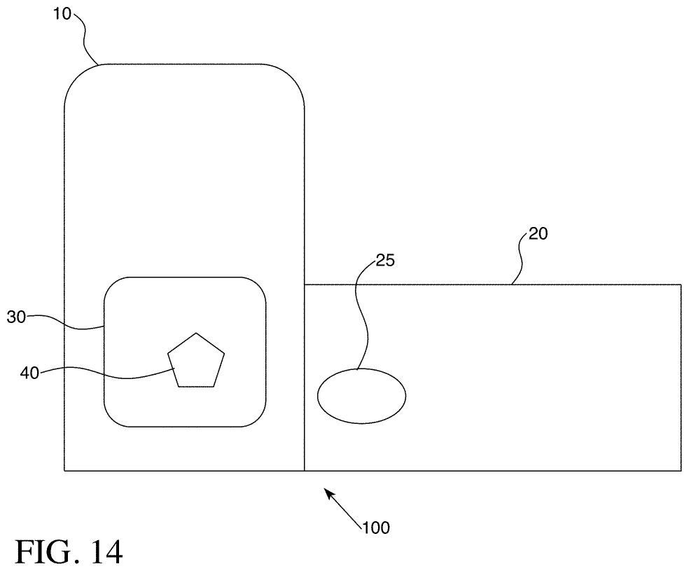

The present invention can be used with any electronic smart devices 10 containing a gyroscope 40 (or gyroscope sensor 40) alone or as a part of an IMU 30, including but not limited to smart phones, tablets, mobile telephones, personal digital assistants, mobile computing devices, etc. (collectively referred to herein as a “smart device(s) 10”). As shown in FIG. 14, a user presses or physically or acoustically touches or acoustically couples 100 a smart device 10 to a specially-instrumented object (an “object 15”) that is equipped with a transducer 25 or is a transmission device 20, which is vibrating and transmitting data through those vibrations. In one embodiment the vibrations are at inaudible ultrasonic frequencies. Upon physical contact, the vibrations propagate through the smart device's chassis, resulting in a signal at the gyroscope 40, the inertial measurement unit (“IMU” 30) containing a gyroscope 40 or the accelerometer 50. One embodiment of the present invention includes sampling the IMU's gyroscope 40 at a high sample rate (32 kHz), enabling the smart device 10 to pick up the vibrations and demodulate them into binary data. Additional information, descriptions and embodiments of the present invention are detailed in the article entitled, “VibroComm: Using Commodity Gyroscopes for Vibroacoustic Data Reception”, which is incorporated herein by reference. See Robert Xiao, Sven Mayer, and Chris Harrison, (2020), VibroComm: Using Commodity Gyroscopes for Vibroacoustic Data Reception, In 22nd International Conference on Human-Computer Interaction with Mobile Devices and Services (MobileHCI '20), Oct. 5-8, 2020, Oldenburg, Germany. ACM, New York, N.Y., USA, 9 pages. https://doi.org/10.1145/3379503.3403540.

Receiver Hardware: For the smart device 10, one example embodiment of the present invention uses an Android smartphone running Android 5.0.1. It will be obvious to one skilled in the art that any smart device 10 that has a gyroscope 40 or an IMU 30 containing a gyroscope 40 can be used for the present invention as well and is hereby incorporated into the present invention. This particular smartphone (an LG Nexus 5) has an InvenSense MPU-6515 IMU 30 built in, which is capable of sampling the accelerometer 50 at 4 kHz and the gyroscope 40 at 32 kHz. The default Linux kernel drivers for Android support a maximum sample rate of 100 Hz, so this particular embodiment of the present invention utilizes a custom kernel driver that configures the IMU 30 into the 32 kHz high-speed sampling mode and disables the low-pass filter. Disabling this low-pass filter causes high-frequency vibrations (above the 16 kHz Nyquist frequency) to appear aliased in the sampled data, instead of being attenuated away. The driver commands the IMU 30 to store this data to an internal FIFO, which is emptied using a burst-read command every 20 ms by the kernel driver. The internal I²C bus is not fast enough to transmit all three axes at 32 kHz. Therefore, this one embodiment of the present invention uses only the z-axis of the gyroscope 40, which was determined to have the highest SNR in an informal test.

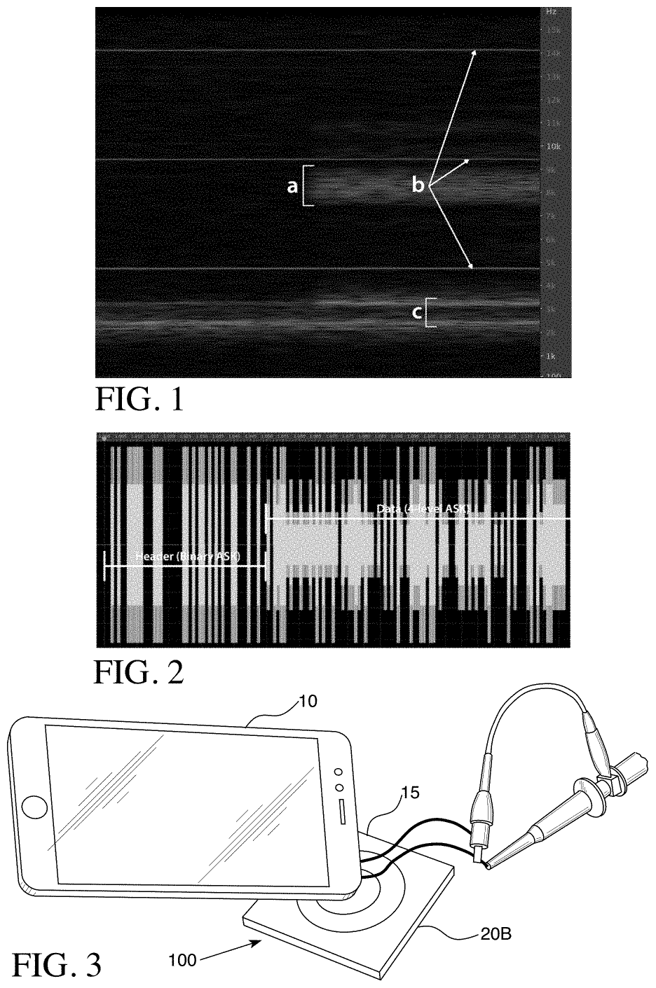

In one embodiment, the MPU-6515's gyroscope 40 is a “vibrating-comb” design—a common type of gyroscope 40 in which a micro-scale comb is vibrated at a fixed frequency fc near a second fixed comb and the capacitance between the two combs is continuously measured. External rotations of the vibrating comb cause it to move out-of-plane, changing the capacitance between the two combs. The comb's fundamental vibration frequency and two of its harmonics can be seen clearly in FIG. 1 at location “b”, which shows a comb frequency at 4.7 kHz and two harmonics (9.4 and 14.1 kHz).

When an external oscillation of frequency f is picked up by the gyroscope 40, the combination of this frequency and the comb frequency produces a pair of beat frequencies at f_{c}+f and f_{c}−f. For instance, as shown in FIG. 1 at location “a”, a DPSK transmission at a frequency of 19.2 kHz is received at an apparent center frequency of 8.2 kHz (19.2+4.7=23.9 kHz, which becomes 32.1−23.9=8.2 kHz after Nyquist aliasing). A spectrogram view of the received data is shown in FIG. 1. Note that the frequency response of the gyroscope 40 is not flat. The response is strongest around 28 kHz, which appears around 2-3 kHz in the received data (FIG. 1 at location “c”) due to Nyquist aliasing, and drops off strongly ±8 kHz from this resonant frequency.

Finally, it is notable that the sampling rate of the device is not exactly 32 kHz. In fact, the sampling rate can vary by up to ±750 Hz depending on device imperfections and the device temperature. In order to correct for the sample rate variation, the driver reports the nanosecond timestamp and total accumulated byte count when reading from the internal FIFO, allowing the user code to compute the average sample rate over a period of time. The comb frequency also varies in approximately a 1:1 fashion with the sample rate, affecting the frequency of the received data.

These effects—sample rate instability, beat frequency, resonant band, and vibrating-comb noise—must be compensated for in order to provide the best possible data transmission rate. In particular, note that these effects are not specific or unique to this model of gyroscope 40—similar effects exist in most gyroscopes 40 of this type. Therefore, it will also be obvious to one skilled in the art that the present invention will work with any similar gyroscope 40 that is in a smart device 10 as long as these effects are compensated for to maximize the data transmission rate.

Alternative embodiments of the present invention utilize an accelerometer 50 instead of a gyroscope 40 as the receiver hardware. It will be obvious to one skilled in the art that an accelerometer 50 can be used to receive transmissions in a manner similar to the gyroscope 40.

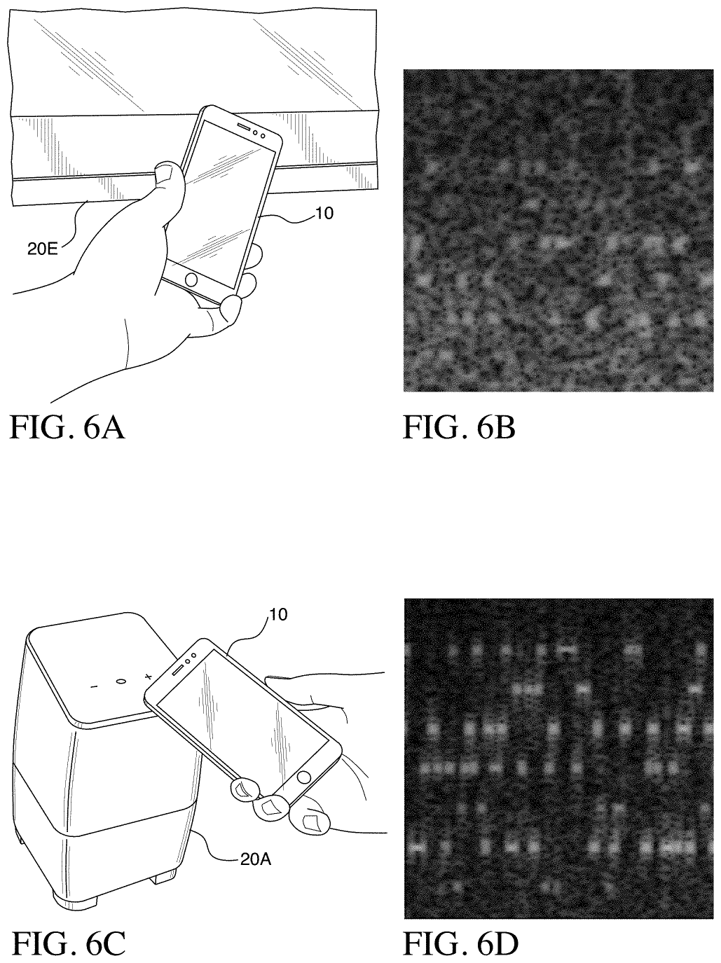

Transmission: The present invention was tested with several objects 15 that were equipped with transducers 25 or one of a variety of transmission devices 20. The present invention works with a wide variety of transducers 25, including but not limited to speakers 20A, voice coils 20C, linear resonance actuators, and most piezoelectric elements, including but not limited to piezoelectric discs 20B. Testing of the present invention focused on one preferred embodiment that utilizes the piezo disc 20B (as a type of piezoelectric element)(shown in FIG. 3) for its size and ability to produce accurate ultrasonic vibrations. It will be understood by one skilled in the art that the broad category of piezoelectric elements encompasses many different devices and structures, all of which are capable of serving the function of acting as a transducer 25 to produce vibrations that transmit data. FIG. 3 illustrates a smart device 10 touching the piezo disc 20B to enable transmission of data. However, it will be obvious to one skilled in the art that other transmission devices 20 can be implemented depending upon the gyroscope 40 and smart device 10 being used, the information being communicated, and the environment in which the transmission is occurring. For example, FIGS. 6A through 6D illustrate proof-of-concept signals from two uninstrumented transmission devices 20. Transmission devices 20 with high-quality vibration actuators (i.e. linear resonant actuators, but not eccentric rotating mass vibration motors) also work. FIGS. 6A and 6B show successful transmission from a television having speakers 20E. FIGS. 6C and 6D show transmission from a wireless speaker 20A. All such variations are hereby incorporated into the present invention. The transmission device 20 should be capable of generating structured vibrations that can be picked up by the gyroscope 40 or other receiver hardware.

One embodiment of the present invention uses a 27 mm PUI Audio piezo bender for the transmission device 20, hooked up via a 3.5 mm TRS connector to a MacBook Pro® computer which provides the modulated ultrasound signal. Piezoelectric elements also have the advantage of extreme low cost (pennies at scale), thin design and low weight, allowing them potentially to be integrated into everyday objects to make them capable of transmitting modulated vibrations. Again, FIG. 3 illustrates smart device 10 touching the piezo disc 20B.

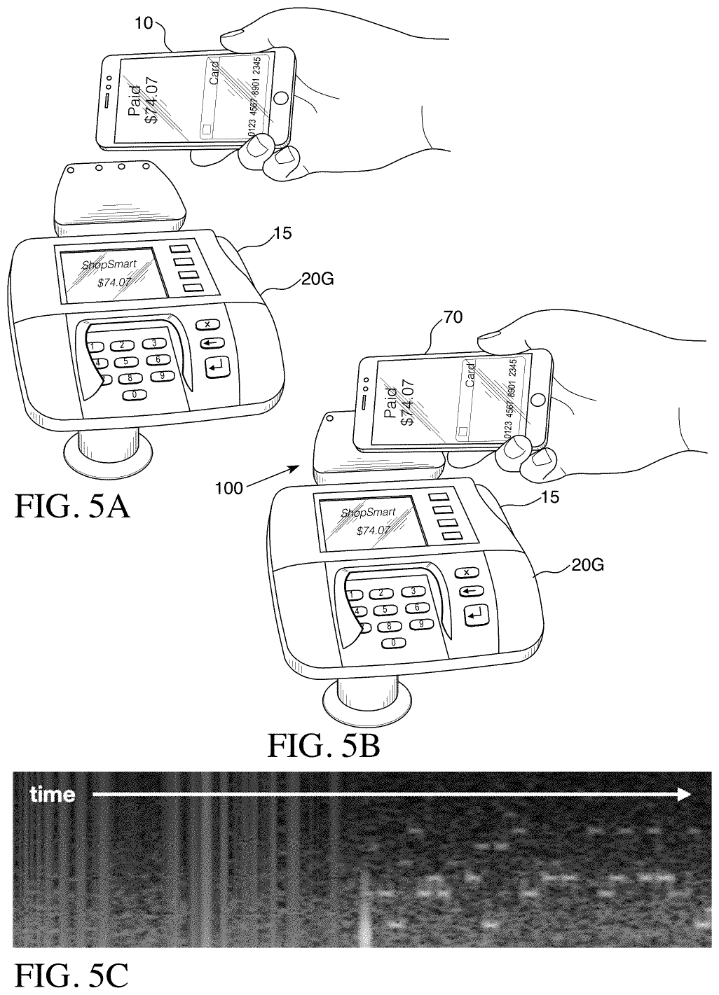

According to the present invention, the vibrations produced by the transducers 25 are “structured”, meaning the vibrations are intentionally designed to transmit data that can be detected by a gyroscope 40 and translated or decoded by an appropriately equipped and configured smart device 10. Data is transmitted by outputting one or more waves at known frequencies, called carrier frequencies. Carrier frequencies are used for some but not all embodiments of the present invention. FIG. 5C illustrates the transmission of data at different frequencies (the y-axis) over time (the x-axis). The dash-type images on the right side of FIG. 5C are the data that is being transmitted. The binary data is converted into a stream of symbols, which are then modulated onto these carrier waves at discrete intervals. To achieve this modulation, the present invention was tested with several well-known approaches, including amplitude-shift keying (“ASK”), phase-shift keying (“PSK”), differential phase-shift keying (“DP SK”), frequency-shift keying (“FSK”), quadrature-amplitude modulation (“QAM”) and on-off keying. Each of these techniques is capable of sending multiple bits per symbol by using different levels; for example, with four amplitude levels, ASK can transmit two bits per symbol. In order to improve robustness to bit errors, the symbols are encoded into levels using binary Gray code, so that receiving a level as its neighboring level will only induce a single bit-flip.

One embodiment of the present invention utilizes orthogonal frequency division multiplexing (“OFDM”) to improve resilience and channel utilization, but this approach was found to be less ideal than a rapidly-modulated single-carrier approach because the unpredictable shifts in the gyroscope's sample rate precluded clean recovery of the orthogonal subcarriers. Similarly, PSK and QAM approaches proved unreliable, as shifts in the sample rate during a message resulted in phase drifts that accumulated over time. However, DPSK, which naturally compensates for phase drift, works quite well, albeit at the cost of doubling the noise level.

For ASK, PSK, and DPSK, the present invention was tested utilizing a carrier frequency of 19200 Hz. For FSK, the present invention was tested at a frequency range of 17200-21200 Hz. In both cases, the goal was to use ultrasound frequencies for inaudibility (above ˜17 kHz), and to avoid the resonant band (which is excited by a 22-24 kHz external oscillation).

In one embodiment of the present invention, the data is packetized to be sent into 1-second long packets, and a header consisting of a fixed 50-symbol sequence is prepended (the left side of FIG. 2). This header allows the start of the message to be detected with very high probability, and provides a basis reference (e.g. phase, amplitude reference) for decoding the remainder of the message.

Rx Software: In one embodiment, receive logic is implemented for ASK, DPSK, PSK, and FSK techniques. Each receiver consists of two parts: a header-search portion that looks specifically for the 50-symbol message preamble, and a decoder that decodes the subsequent message using the channel properties identified in the header. Data reception starts by converting the received data to a constant 32000 Hz sample rate using a phase-preserving sinc-based resample filter. Then, for each carrier frequency (1 carrier for ASK, DPSK, 1-8 carriers for FSK), the received frequency is estimated using a device-specific constant for the comb frequency and the received sample rate. Finally, a fourth-order Chebyshev band-pass filter is designed and applied to select the carrier. These steps correct for the received frequency offsets due to the comb frequency, as well as the sample rate drift.

ASK Decoding: Amplitude shift keying modulates the amplitude of the carrier frequency. The header is modulated using binary (two-level) ASK for ease of recognition. To find the header, the present invention, in one embodiment, scans across the filtered data, fitting sliding windows to this ideal ASK-modulated preamble. To fit a sliding window, the window is split into symbol-sized units of length N and the amplitude of the received carrier frequency fir is computed:

$$amplitude = \vert {\sum }_{n = 0}^{N} {x}_{n} {e}^{2 π \text{?} / {f}_{cr}} \vert$$

$$\text{?} \text{indicates text missing or illegible when filed}$$

where xₙ is the n^{th} sample in the symbol. One embodiment of the present invention uses the median of the amplitudes within the window as a threshold to produce a sequence of binary bits and compares this sequence to the preamble. If fewer than 8 errors (16%) are found—a 1 in 9.5 million chance of occurring at random—then an assumption is made that the present invention has located a header. The present invention, in one embodiment, then refines the header position by looking for the nearby window with the highest separation in amplitudes between ‘0’ bits and ‘1’ bits. Decoding then proceeds to walk over sliding windows of the data portion, computing amplitudes relative to the reference amplitudes from the header and outputting the relevant discrete symbol (after undoing the Gray code).

DPSK Decoding: Differential phase shift keying modulates the phase of the carrier frequency, where the data is encoded in the difference between phases in adjacent symbols. It is significantly more robust to phase drift issues than ordinary phase-shift keying, but it reduces the signal-to-noise ratio (“SNR”) by compounding errors from two symbols.

Because the sample rate drifts with time, and the signal is aliased across the (drifting) Nyquist boundary, the phase of the carrier frequency drifts with time. This is approximated by the relation θ′ᵢ=θᵢ+iAθ where θᵢ is the original phase at symbol i, θ′ᵢ is the received phase, and Δθ is the average phase drift.

The presence of this accumulating phase drift causes PSK data reception to fail. Even if it is carefully estimated, small variances will compound over the length of a message. By contrast, small variances in the phase drift have only small impacts on DPSK due to its differential nature.

To find the PSK-encoded header, the present invention, in one embodiment, scans across the filtered data and fits sliding windows to the ideal preamble. To fit a sliding window to the PSK preamble, this embodiment of the present invention computes the phase of each symbol:

$${ϕ}_{i}^{′} = arg ( {\sum }_{n = 0}^{N} {x}_{n} {e}^{2 π \text{?} / {f}_{cr}} )$$

$$\text{?} \text{indicates text missing or illegible when filed}$$

The present invention then computes the estimated phase drifts φᵢ=φ′ᵢ−θᵢ (this assumes that the window matches the header). If these were not angles, one could use least-squares to estimate Δθ and θ₀ in the linear relation φᵢ=iAθ+θ₀. However, circular wraparound prevents this approach from working. Instead, the present invention makes an initial estimate using

$${Δ}^{′} θ = ( {\sum }_{i = 1}^{k - 1} {ϕ}_{i} - {ϕ}_{i - 1} ) / ( k - 1 )$$

where k=50, and then applies linear least-squares to

$${ϕ}_{i} + 2 π [ \frac{{i Δ}^{′} θ - {ϕ}_{i}}{2 π} ] = i Δ θ + {θ}_{0}$$

where [ ] is the rounding operator. This reconstructs the “unwrapped” phase values, allowing the invention to recover the phase drift accurately. It works as long as the initial estimate is off by no more than 2π/k radians. Once an estimated phase drift has been recovered, the present invention can binarize the adjusted phases in the window and match them to the PSK payload. As before, the present invention declares that it has found a header if fewer than 8 bits are in error. Decoding a DPSK transmission consists of walking over the sliding windows of the data portion, computing phases relative to the prior window, and outputting the corresponding symbol.

FSK Decoding: Frequency shift keying switches between different carrier frequencies depending on the symbol. The FSK header consists of a fixed random permutation h of [0, 1, 2, . . . , 49] modulo the number of levels, ensuring an even distribution of frequencies for sampling purposes. To find the header, one embodiment of the present invention fits sliding windows to the preamble by comparing the amplitudes of each carrier frequency c in each symbol i, producing a sequence of vectors vᵢ. To account for variable frequency sensitivity and non-uniform background noise, a set of reference vectors is constructed

r_{c,c}=v̅_̅{̅i̅,̅c̅}̅ w̅h̅e̅r̅e̅ h̅ᵢ̅=̅c̅

r_{c,d}=v̅_̅{̅i̅,̅d̅}̅ w̅h̅e̅r̅e̅ h̅ᵢ̅≠̅c̅ for c≠d

where x̅ indicates the mean of x. Then, to extract FSK symbols from an amplitude vector, the present invention simply finds the closest r_{c} vector (by Euclidean distance) and output c, which is done for both the header and the payload.

Evaluation: An experiment was run on certain embodiments of the invention to validate the robustness and performance of the invention. In order to ensure that the invention was not over-optimizing the system, the system was tested with three different Nexus 5s, one of which was never used during the development of the system. The three devices were calibrated by obtaining their baseline comb-sample rate offsets, but otherwise did not engage any device-specific configuration.

The experiment used the piezo throughout as the transmission device 20, pressing the phone 10 down lightly to ensure physical contact or acoustic touching 100. Data was collected for each combination of modulation (FSK, ASK, PSK, DPSK), bits per symbol (1, 2, 3, 4, with the exception of FSK which only went up to 3), and symbol rate (500, 1000, and 1250). In total, there were 45 conditions. For each condition, 25 different codes were generated, and each code was tested 6 times, for a total of 150 data points per condition per device. Thus, a total of 20,250 instances over the course of 30 hours of continuous data transfer were collected, representing a total of 44,550,000 of vibro-acoustically transmitted data.

An additional 2,334 instances of data were collected in an aircraft (Boeing B787) using one of the devices. An analysis of the bit errors in this set showed no significant differences, so it was merged with the main set. Two hundred seventy (270) instances of data also were collected with various music playing at maximum volume out of the phone's own speakers. An analysis of this data showed a significant increase in bit errors for ASK decoding, but no significant effect on FSK or DPSK techniques, suggesting that phase- and frequency-based modulations of the present invention are inherently robust to acoustic noise.

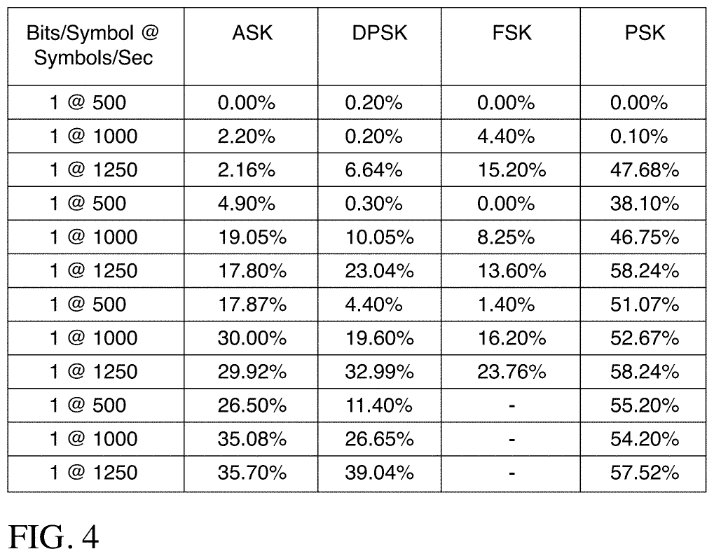

Results: Of the 22,584 packets transmitted, 78 (0.3%) were not detected at all (i.e. the header was not found). The vast majority (73) of these errors were from the 1250 Hz symbol rate condition; thus, for the 500 Hz and 1000 Hz conditions the table shown in FIG. 4 shows the 95th percentile bit error rates across all conditions, i.e. 95% of packets had lower error rates. For PSK, most conditions quickly yield bit error rates approaching 50%, which is as bad as random noise. This is primarily due to the problem of phase drift. By contrast, the DPSK modulation performs significantly better.

The 95th percentile bit error rates are useful for calculating the effective bit rate, after subtracting the necessary error correction overhead. A typical analysis uses a correction percentage of twice the error rate, and coding schemes such as Turbo Codes achieve this rate in practice.

The best overall condition was FSK modulation at 3 bits per symbol, 1000 symbols per second, which is a raw bit rate of 3000 bits/sec. With a 95th percentile BER of 16.20%, the effective bit rate is 2028 bits/sec. In other words, the present invention can transmit error-corrected data at 2028 bits/sec and expect that 95% of packets will be received successfully. For DPSK, the best condition was 4 bits per symbol and 1000 symbols per second. With a BER of 26.65%, this is an effective bit rate of 1868 bits/sec. With ASK, the best condition was 2 bits per symbol and 1250 symbols/sec (BER 17.80%), for an effective bit rate of 1627 bits/sec.

For reference, Ripple—the fastest IMU-based transmission technique that could be found in the literature—used 80th percentile BER (i.e. 20% of packets lost) to obtain an effective bit rate of 196.6 bits/sec. Viband was 155 bit/sec at 80th percentile BER. Neither paper reports 95^{th} percentile BER, which would yield worse results. See Laput, G., Xiao, R. and Harrison, C. (2016), ViBand: High-Fidelity Bio Acoustic Sensing Using Commodity Smartwatch Accelerometers, In Proceedings of the 29th Annual Symposium on User Interface Software and Technology (UIST '16)(ACM, New York, N.Y., USA, 321-333. DOI: https://doi.org/10.1145/2984511.29845820; Roy, N., Gowda M. and Choudhury R. R. (2015), Ripple: communicating through physical vibration; In Proceedings of the 12th USENIX Conference on Networked Systems Design and Implementation (NSDI'15)(USENIX Association, Berkeley, Calif., USA, 265-278).

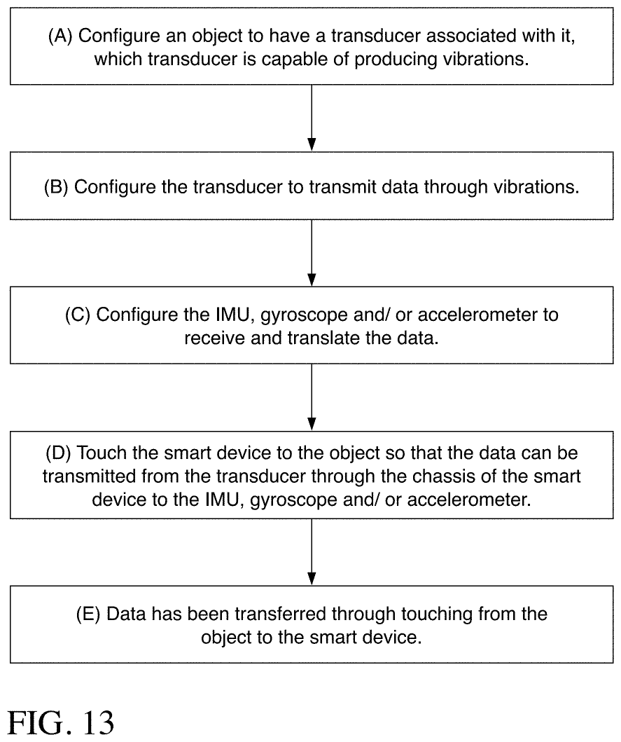

Non-limiting Example Uses: The overarching method embodied in the present invention is illustrated in FIG. 13, whose steps can be performed in various orders and not solely the order shown in FIG. 13. The method entails configuring an object 15 to have associated with it a transducer 25 that is capable of producing vibrations (FIG. 13 at A). The transducer 25 is configured to transmit data through the vibrations (FIG. 13 at B). A smart device's IMU 30, gyroscope 40 or accelerometer 50, is configured to receive and translate or decode the data (FIG. 13 at C). By touching the smart device 10 to the object 15, the data is transmitted from the transducer 25 through the chassis of the smart device to the IMU 30, gyroscope 40 or accelerometer 50 (FIG. 13 at D and E). This method can be employed by various smart devices 10, objects 15 and for various purposes and all such uses are included within the scope of this invention. Applications that require a one-way transfer of small amounts of data are ideal for the present invention. A few non-limiting examples (explained more fully herein) include downloading a restaurant's menu from its door, a retail coupon from an in-store display, or a business card from a room placard. Such data could be continuously transmitted as single packets. In uses with much larger payload requirements, it may be more practical to send a UID, for instance, a web URL. The receiving smart device 10 can then use e.g., its faster cellular connection to retrieve the data (e.g., downloading a subway map or song after a user taps their phone to a public display).

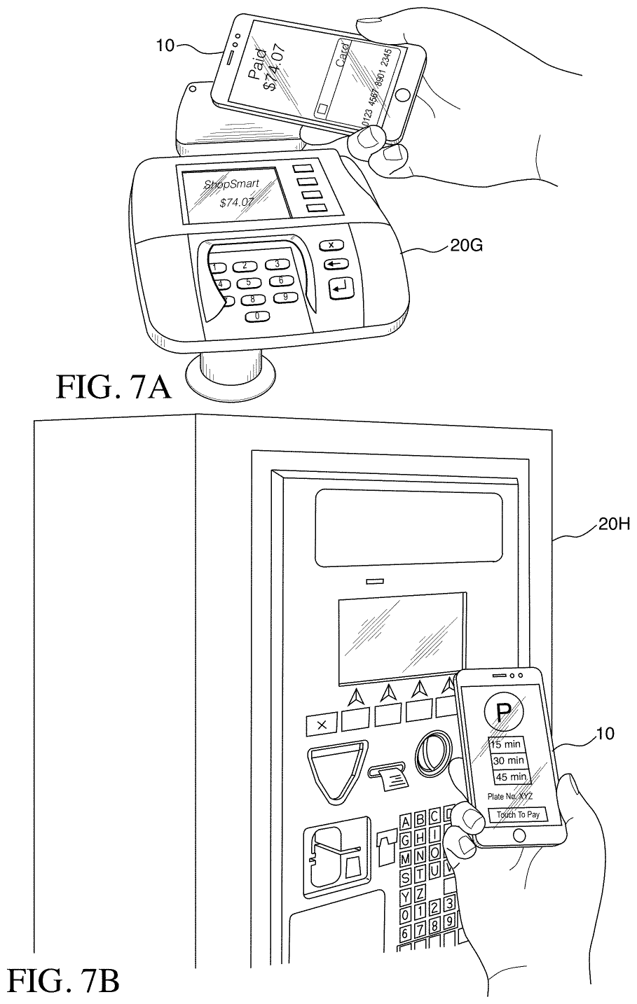

Payments are perhaps the most straightforward example use. FIGS. 7A and 7B illustrate how transmission devices 20 (a payment device 20G at a store (7A) and a parking machine 2011 (7B) can be structured to emit unique transaction identifiers, which can be received by smart devices 10 enabled according to the present invention, allowing for rapid payment. A smart device 10 and transmission device 20 according to the present invention operate according to a method that is fast and explicit with greater security. However, the present invention could also be used in lieu of technologies like NFC. Even a short tap ( [symbol] 100 ms, or around 200 bits) would be sufficient to transfer a unique transaction identifier and ephemeral encryption key, allowing the transaction to be completed securely over a WiFi or cellular connection. Devices and systems according to the preset invention are significantly harder to spoof compared to wireless techniques like NFC (interception of signals is possible but would require specialized equipment for long range vibrometry). An attacker would also have to be in physical contact with the phone or reader (as opposed to merely being nearby).

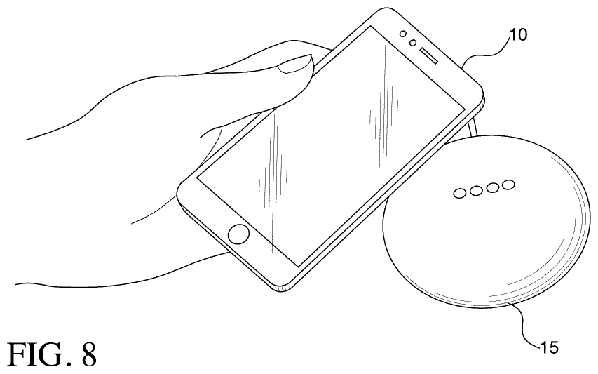

Pairing devices according to the present invention has significant advantages over techniques that are currently in use. Today, pairing devices using technologies like Bluetooth is a cumbersome affair, often requiring expiring PINs to increase security. Part of the problem with wireless methods is the lack of guarantees that devices are actually next to one another (and not e.g., in a neighbor's apartment). Even “near field” technologies such as NFC have trouble disambiguating between true touch and being nearby, which is problematic in e.g., busy retail settings. Devices and systems designed according to the present invention offers stronger guarantees of physical proximity, as well as a pairing interaction that is much more explicit and intuitive: devices must be physically held together (e.g., a smartphone, and Bluetooth speaker). FIG. 8 illustrates how a smart device 10 and a transmission device 20 can be intuitively paired according to the present invention. The present invention's use of a smart device's gyroscope sensor 40 means that objects hovering above the surface of the transmission device 20 receive no data (FIG. 5A). Only when physical contact is made is data received (FIG. 5B). This makes interactions targeted and explicit, requiring presence and intent.

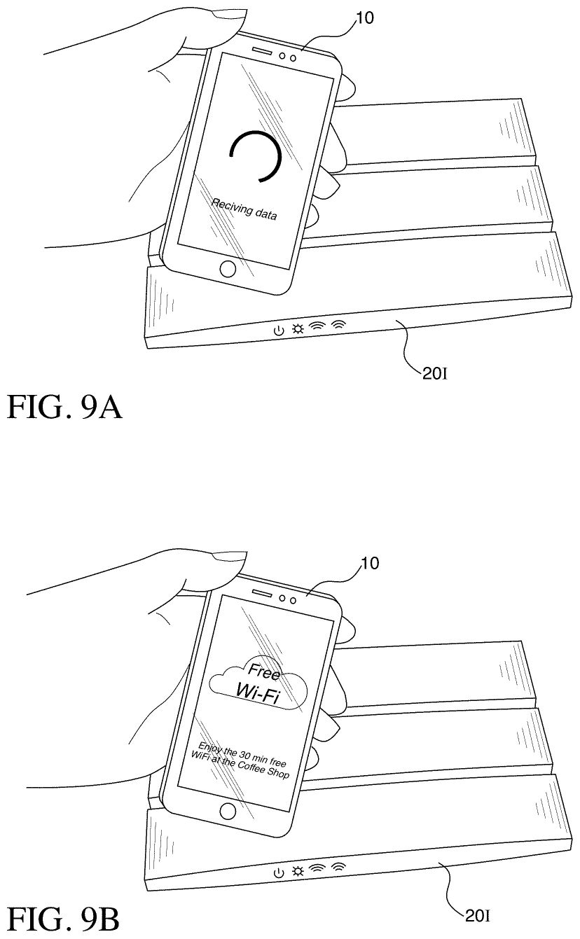

Permanent device-device pairing is not required for many use cases, especially interactions that might only last for minutes or hours. One example of this type of short-lived pairing is guest WiFi access, where a user could touch the access point to confirm they are inside e.g., a cafe, which transmits a one-time token for temporary internet access. One such scenario is illustrated in FIGS. 9A and 9B where temporary guest WiFi access is as easy as tapping a smart device 10 to a router 20I.

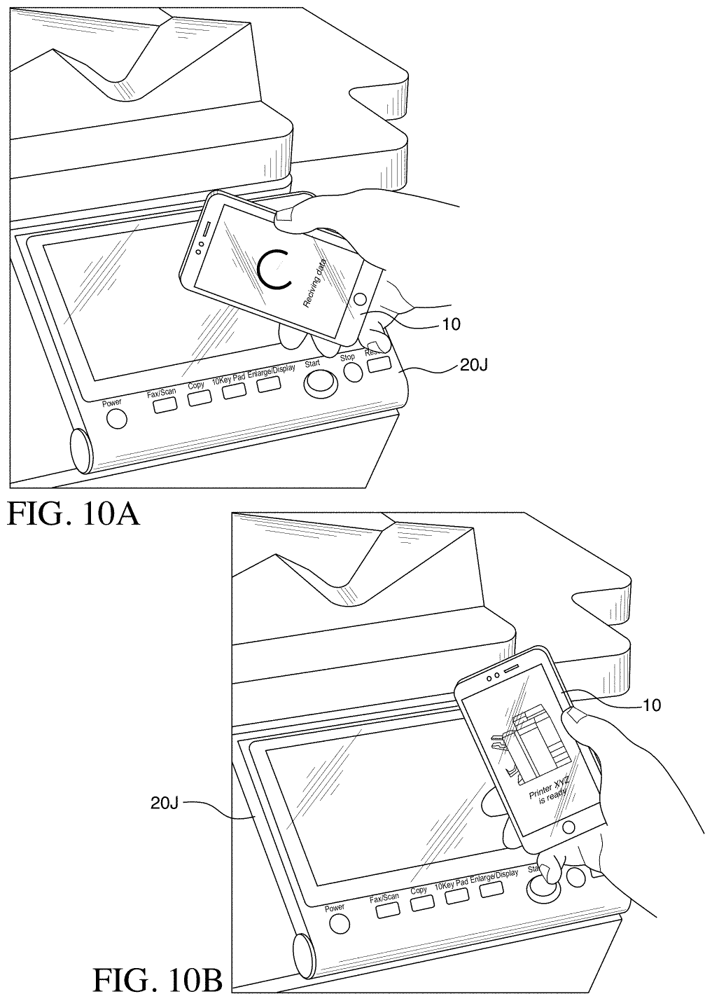

Another class of pairing occurs with semi-public, shared devices. A canonical example are office printers 20J. As shown in FIGS. 10A and 10B, the front panel of the printer 20J can be designed to repeatedly transmit all necessary model and network details to setup printing, including extra security credentials if needed. Such an approach would inherently only allow those with physical access to the premise access to the printer 20J.

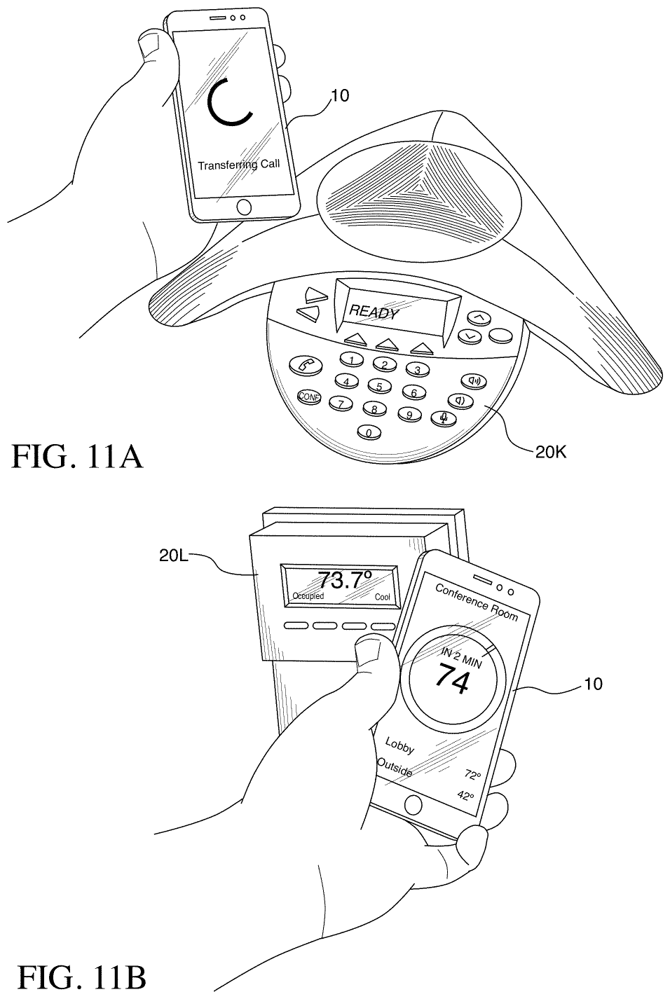

There are also instances where a function or process on a smart device 10 might wish to be transferred to another. For example, transferring a call one took on a conference room speakerphone 20K to a smartphone 10 (FIG. 11A) or transferring a video stream to a larger screen. Another embodiment of the present invention comprises having individual smart devices 10 equipped with both transducers 25 and gyroscope sensors 40 so that an individual smart device 10 can both transmit data using vibrations and receive and translate data that is sent as structured vibrations.

The present invention is especially useful for rapidly launching companion apps on smartphones. For example, touching one's smartphone 10 to a smart thermostat 20L launches the manufacturers app, offering touchscreen controls and advanced settings (see FIG. 11B).

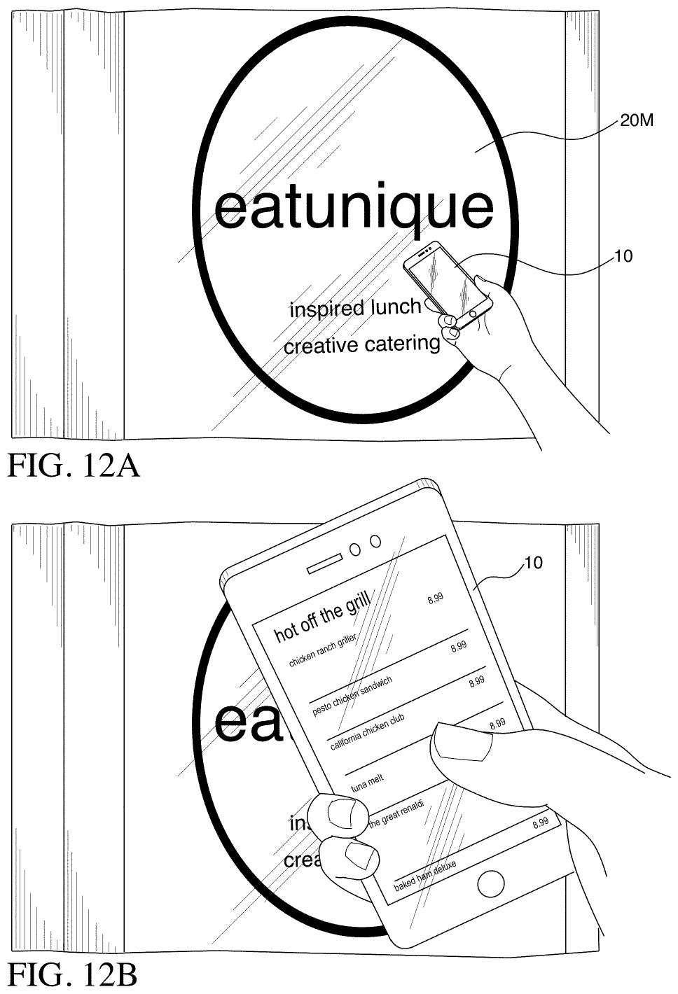

Although the present invention may not be suitable for transmitting very large files, it could transmit server details (e.g., IP/port/password) or a URL that allows for download over faster means, such as WiFi of cellular. This could allow, for instance, a user to download a menu from a restaurant window 20M that has a transmitter 20D on it; see FIGS. 12A and 12B.

In one embodiment, the current invention is limited to the receipt of data by the smart device 10, and not the transmission of data from the smart device 10. In other embodiments, the invention is combined with another transmission method (e.g., Wi-Fi, Bluetooth, cellular) for many applications. The preferred embodiment of the present invention involves pressing a smart device 10 to a transmission device 20 directly. In some embodiments of the present invention placing transducers/transmitters elsewhere (e.g., corner of a TV 20E), results in damping and multipath obfuscation of the signal significantly, and dramatically increased bit error rate. Nonetheless, even in those embodiments, the present invention is able to use the resonant frequency of the gyroscope 40 to transmit data through some physical objects, albeit at a much lower bandwidth.

Finally, the vibratory signals used in the present invention are very subtle, almost imperceptible to human touch. As such, poor acoustic coupling will render the signal unrecoverable. For example, some smartphone cases may reduce the signal by 10 dB or more and subsume the signal into the noise floor. Also, as there are innumerable IMU models 30 and vendors, different embodiments of the present invention may need to be adjusted to each model and vendor. That said, it will be obvious to one skilled in the art that the fundamental principles of operation should be applicable to all smart devices 10 that are equipped with gyroscopes 40.

What is claimed is:

1. A method of transmitting data, through physical touching, from an object to a smart device comprising a gyroscope sensor, the method comprising:
Configuring the object with a transducer that is capable of producing vibrations; and
Configuring the transducer to transmit data through the vibrations,
Whereby, when the smart device is physically touching the object, the gyroscope sensor detects the vibrations and the transmitted data.

2. The method of claim 1, wherein the smart device is selected from the group consisting of a smart phone, a tablet, a mobile phone, a personal digital assistant and a mobile computing device.

3. The method of claim 1, wherein the smart device is configured to receive and translate the data to information usable by the smart device.

4. The method of claim 1, wherein the smart device also comprises an inertial measurement unit, which contains the gyroscope sensor.

5. The method of claim 1, wherein the vibrations are ultrasonic vibrations.

6. The method of claim 1, wherein the data is transmitted by using more than one frequency.

7. The method of claim 1, wherein the gyroscope sensor is of a vibrating-comb design.

8. The method of claim 1, wherein the transducer is selected from the group consisting of a speaker, a piezoelectric element, a piezoelectric disc, a voice coil, and a linear resonance actuator.

9. The method of claim 1, wherein the data is transmitted by outputting at least one frequency and the data is converted into a stream of symbols.

10. The method of claim 9, wherein the stream of symbols are modulated using at least one approach selected from the group consisting of amplitude-shift keying, phase-shift keying, differential phase-shift keying, frequency-shift keying, quadrature-amplitude modulation and on-off keying.

11. A method of receiving data from an object that produces vibrations, comprising:
Selecting a smart device comprising a gyroscope to receive data that is in the form of vibrations; and
Touching the smart device to the object configured with a transducer that is configured to produce vibrations and to transmit data through the vibrations, whereby the data can be transmitted from the object to the smart device.

12. The method of claim 11, also comprising configuring the smart device to translate the data.

13. A system for transmitting data through physical touching, comprising:
An object;
A transducer that is associated with the object and capable of producing structured vibrations for transmission of data; and
A smart device equipped with a gyroscope configured to receive the data from the transducer when the smart device touches the object.

14. The system of claim 13, wherein the smart device is selected from the group consisting of a smart phone, a tablet, a mobile phone, a personal digital assistant, and a mobile computing device.

15. The system of claim 13, wherein the smart device is configured to translate the data.

16. The system of claim 13, wherein the smart device further comprises an inertial measurement unit, which contains the gyroscope.

17. The system of claim 13, wherein the vibrations are ultrasonic vibrations.

18. The system of claim 13, wherein the data is transmitted by using more than one frequency.

19. The system of claim 13, wherein the smart device also comprises a driver that is configured to sample the gyroscope, and whereby the smart device is configured to pick-up the vibrations and demodulate them into binary data.

20. The system of claim 13, wherein only one axis of the gyroscope is utilized.

21. The system of claim 13, wherein the gyroscope is of a vibrating-comb design.

22. The system of claim 13, wherein the transducer is selected from the group consisting of a speaker, a piezoelectric element, a piezoelectric disc, a voice coil, and a linear resonance actuator.

23. The system of claim 13, wherein the data is transmitted by outputting at least one frequency and the data is converted into a stream of symbols.

24. The system of claim 23, wherein the stream of symbols is modulated using at least one approach selected from the group consisting of amplitude-shift keying, phase-shift keying, differential phase-shift keying, frequency-shift keying, quadrature-amplitude modulation, and on-off keying.

25. A secure payment method comprising touching a smart device comprising a gyroscope, which smart device is configured to receive and translate data, to an object having a transducer, which transducer is capable of producing vibrations that transmit data,
Whereby the touching of the smart device to the object enables the data from the object to be transmitted securely to the gyroscope.

26. A method of transmitting data, through acoustic coupling, from an object to a smart device comprising a gyroscope sensor, the method comprising:
Configuring the object with a transducer that is capable of producing vibrations; and
Configuring the transducer to transmit data through the vibrations,
Whereby, when the smart device is acoustically coupled to the object, the gyroscope sensor detects the vibrations and the smart device converts the vibrations and data to information usable by the smart device.
